(19) United States
(12) Patent Application Publication
(10) Pub. No.: US 2019/0240860 A1
(43) Pub. Date: Aug. 8, 2019

(54) Laminated-Veneer-Lumber Product and Method for Producing the Same

(71) Applicant: Hanses Sägewerkstechnik GmbH & Co. KG, Meschede-Rembinghausen (DE)

(72) Inventor: Josef Hanses, Meschede-Remblinghausen (DE)

(73) Assignee: Hanses Sägewerkstechnik GmbH & Co. KG, Meschede-Rembinghausen (DE)

(21) Appl. No.: 16/318,502

(22) PCT Filed: Jul. 5, 2017
(86) PCT No.: PCT/EP2017/066829

§ 371 Date: Jan. 17, 2019

(30) Foreign Application Priority Data
Jul. 22, 2016 (DE) 10 2016 113 548.8

(51) Int. Cl. B27D 1/10

(52) U.S. Cl. CPC B27D 1/10

(57) ABSTRACT

A laminated veneer lumber product made from veneer panels (T) which are glued and pressed to one another in a plurality of layers, at least one layer having a plurality of veneer panels (T) which butt against one another and, at the butt joints, have a respective scarfing zone (Z) in which the thickness of the veneer panel decreases in the direction of an outer periphery (S) of the scarfing zone (Z), the periphery at the same time forming the edge of the veneer panel (T), and which is delimited in the inward direction by an inner periphery (R) from which the veneer panel has its full thickness (d), wherein at least the inner periphery (R) of the scarfing zone (Z), as seen in plan view, runs in an undulating manner.

The invention relates to a laminated veneer lumber product made from veneer panels which are glued and pressed to one another in a plurality of layers, at least one layer having a plurality of veneer panels which butt against one another and, at the butt joints, have a respective scarfing zone in which the thickness of the veneer panel decreases in the direction of an outer periphery of the scarfing zone, said periphery at the same time forming the edge of the veneer panel, and which is delimited in the inward direction by an inner periphery from which the veneer panel has its full thickness.

DE 887 702 C discloses a method of scarfing veneer panels from which laminated veneer lumber products will then be formed. When forming the laminated veneer lumber products, the veneer panels which belong to the same layer are butted against one another such that they overlap with their scarfing zones. In this way, a good joint between veneer panels is achieved without that, on the other hand, the material becomes too thick in the overlapping zone.

It is an object of the invention to further improve the homogeneity of laminated veneer lumber products.

In order to achieve this object, according to the invention, at least the inner periphery of the scarfing zone, as seen in plan view, runs in an undulating manner.

In conventional laminated veneer lumber products, the inner periphery of the scarfing zone extends straight and in uniform distance from the outer periphery which is also straight. Since, at the inner periphery of the scarfing zone, the flat surface of the main part of the veneer panel joins the downwardly slanting surface of the scarfing zone, the inner periphery of the scarfing zone forms a knuckle line at which the inclination of the surface of the veneer changes abruptly. When the veneer panels are pressed, the parts of the veneer panels that are superposed one upon the other are abruptly kinked at the knuckle points, so that the certain discontinuities are created in the product. Because the inner periphery of the scarfing zone runs in an undulating manner according to the invention, a gradual transition from the main part of the veneer panel to the scarfing zone is obtained instead of a sharp knuckle line. Moreover, the scarfing zone has an undulating profile also in the thickness direction, which profile is at least partly smoothened out again when the veneer panels are pressed. In this way, a greater compressibility of the veneer and, therewith, a better distribution of mechanical strains within the product is achieved and the formation of local stress concentrations is avoided. Also, when the veneer panels are laid, a larger tolerance in view of positional deviations is achieved, because gaps or material doublings, which may be produced in the laying process because the outer edge of the one veneer panel does not coincide exactly with the inner periphery of the scarfing zone of the other veneer panel, are mitigated by the wavy shape of this periphery.

More specific optional features of the invention are indicated in the dependent claims.

The invention relates also to methods and apparatus for forming laminated veneer lumber products according to the invention.

In one embodiment, the scarfing zones having the wavy periphery are formed by so-called wet scarfing already during the peeling of the veneer. In another embodiment, the scarfing zones are formed by so-called dry scarfing by means of a milling or grinding tool only after the veneer panels have been dried.

Embodiment examples will now be described in conjunction with the drawings, wherein:

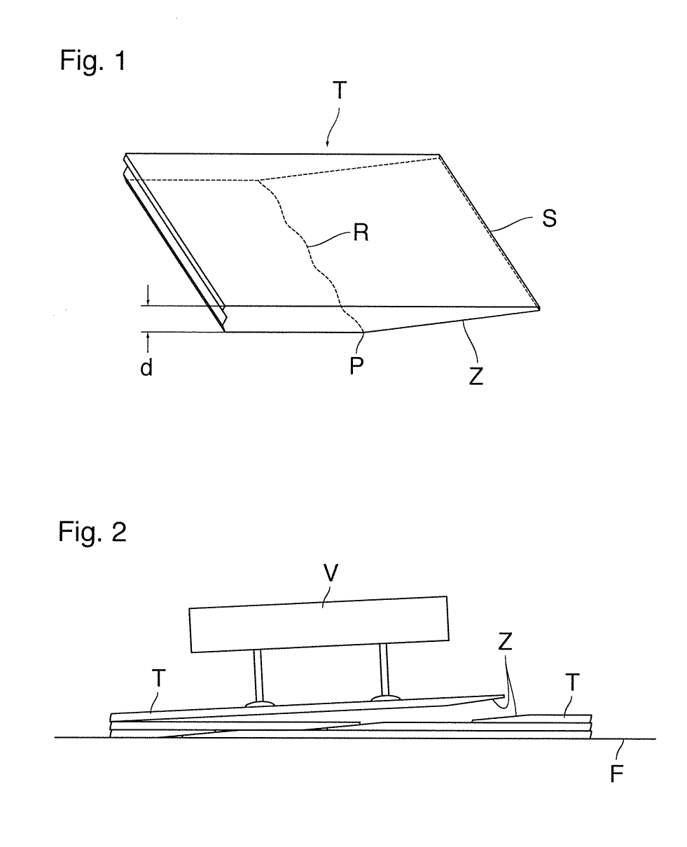

FIG. 1 is a perspective view of a part of the veneer panel for a laminated veneer lumber product according to the invention;

FIG. 2 is a schematic sketch illustrating a laying process in the production of laminated veneer lumber;

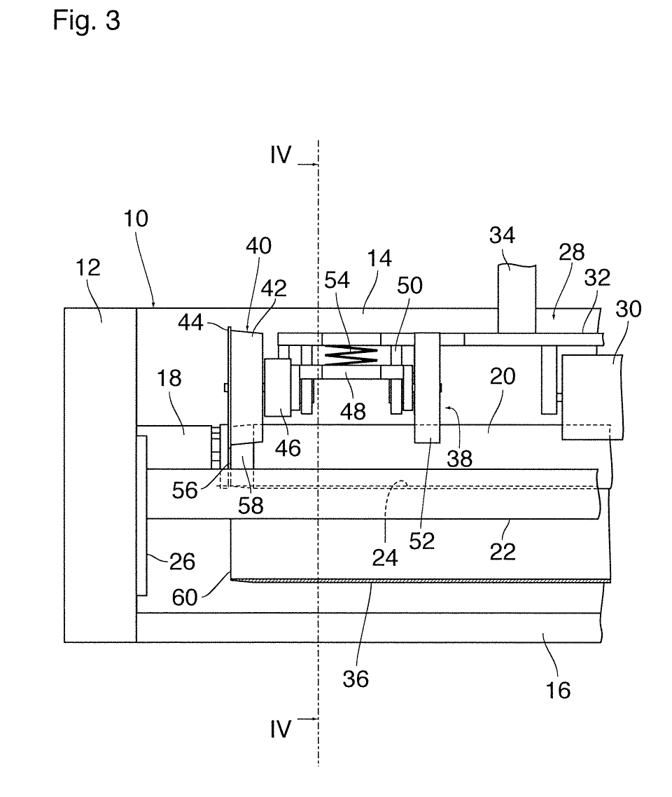

FIG. 3 is a schematic view of an end of a veneer peeling apparatus as seen from the direction in which the peeled veneer is discharged;

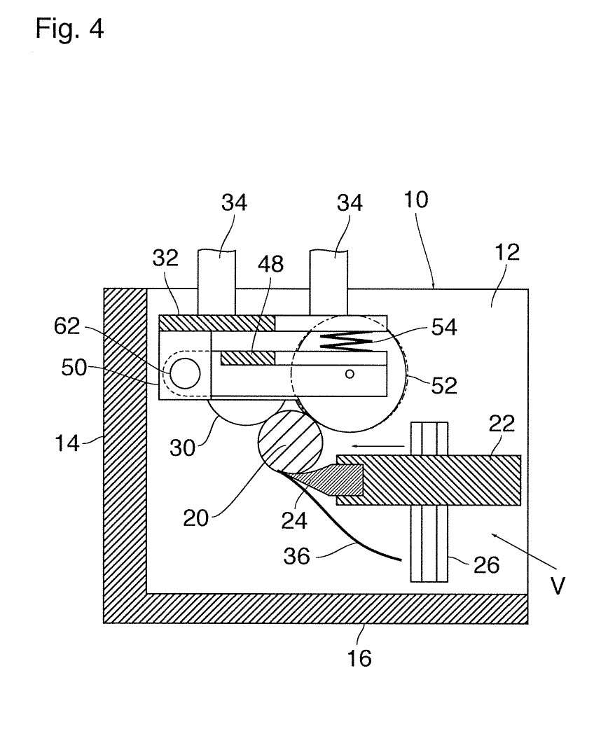

FIG. 4 is a sectional view along the line IV-IV in FIG. 3;

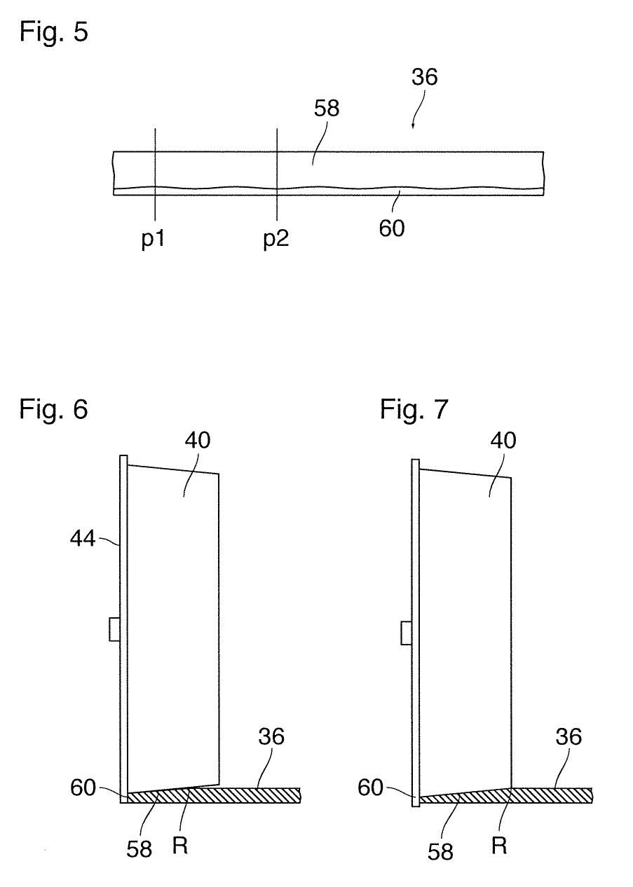

FIG. 5 is a front view of a veneer panel having a scarfing zone;

FIGS. 6 and 7 are sketches illustrating a method of forming the scarfing zone shown in FIG. 5;

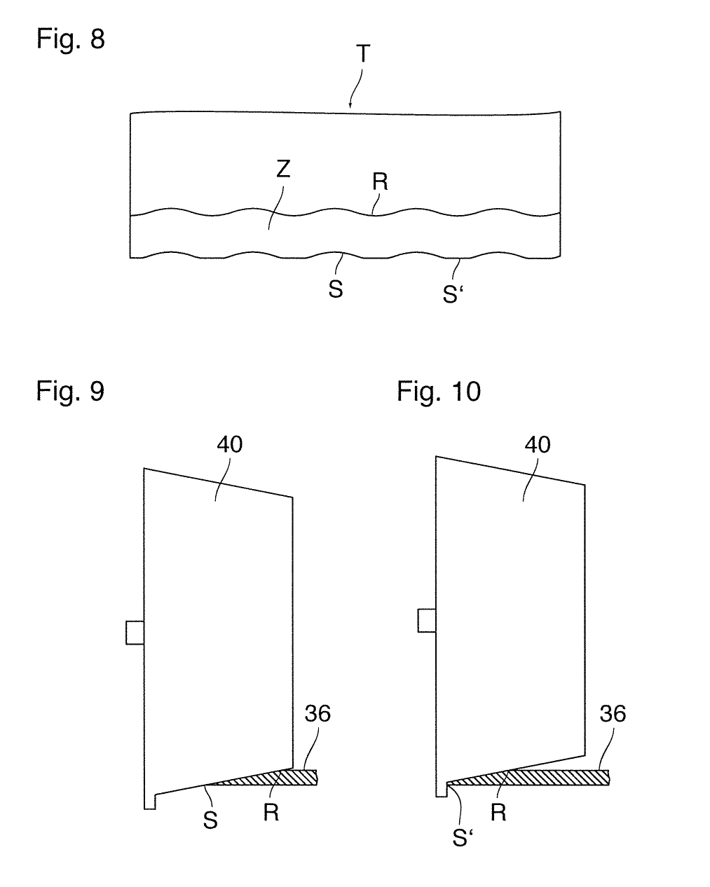

FIG. 8 shows a scarfing zone of a veneer panel according to another embodiment in a plan view;

FIGS. 9 and 10 are sketches for illustrating a method of forming the scarfing zone shown in FIG. 8;

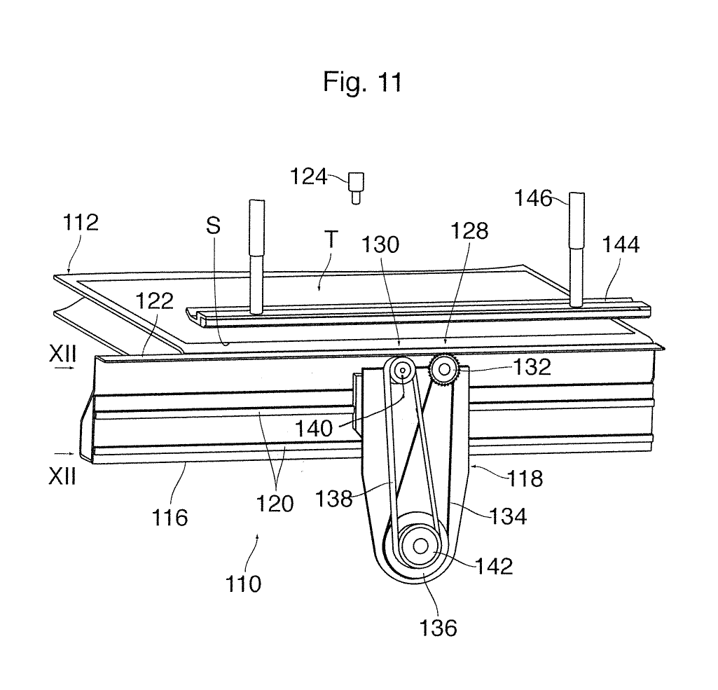

FIG. 11 is a perspective view of essential parts of an apparatus for scarfing veneers according to another embodiment;

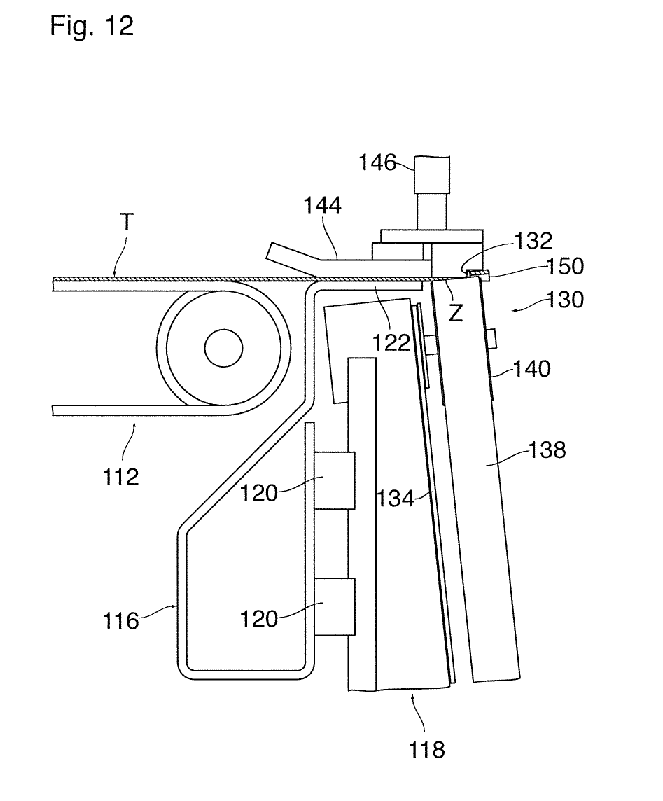

FIG. 12 is a side view of the apparatus as seen in the direction of arrows XII-XII in FIG. 11;

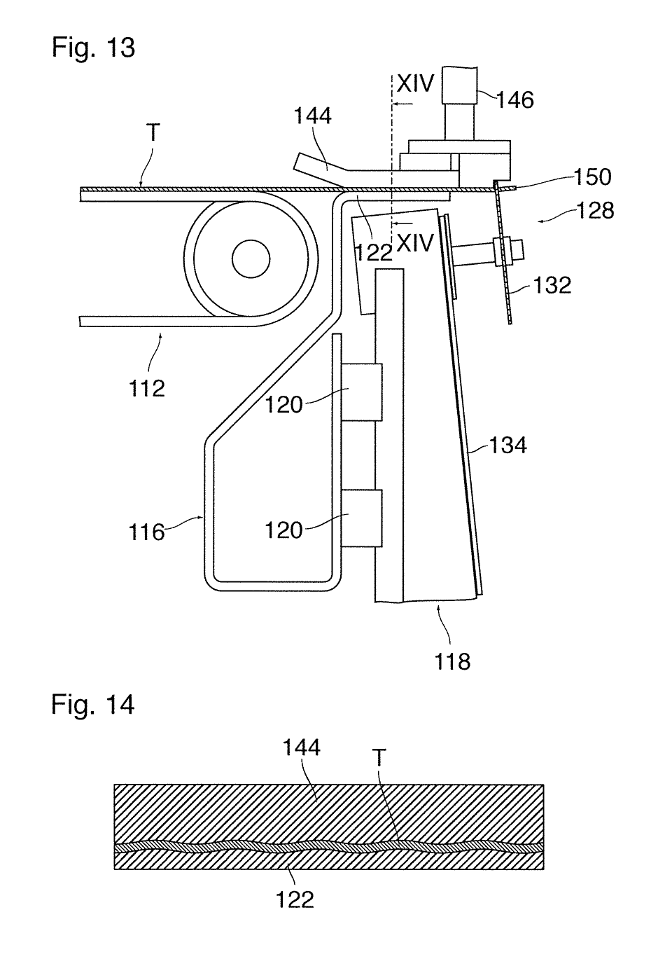

FIG. 13 is a view analogous to FIG. 2, wherein, however, parts of the apparatus have been left away in order to show other parts more clearly; and

FIG. 14 is a sectional view taken along the line XIV-XIV in FIG. 13.

FIG. 1 shows, in a perspective view, a section of an edge zone of a veneer panel T which has a scarfing zone Z at the bottom side. In this scarfing zone, the thickness of the veneer panel decreases from the nominal value d which it has in the main part of the panel to almost zero at the outer periphery S of the veneer panel and of the scarfing zone. Within the scarfing zone Z, the bottom surface of the veneer panel in FIG. 1 has a constant slope. Towards the interior of the veneer panel, the scarfing zone Z is delimited by a periphery R at which the veneer panel reaches its nominal thickness d.

It is a particular feature of the veneer panel T that the inner periphery R of the scarfing zone Z is not straight but has a wavy shape. This has the effect that the position P at which the bottom surface of the veneer panel has a kink varies periodically along the periphery S of the veneer panel.

FIG. 2 schematically illustrates a process in which, by means of a stacking device V, glued veneer panels T of the type shown in FIG. 1 are laid in the form of a so-called “book” in which the veneer panels T are superposed in several layers on a conveyor F. Then, by means of the conveyor F, the veneer panels are conveyed, in the form of an endless string, to a continuous press where they are compressed by applying pressure and heat so as to form a laminated veneer lumber body.

As is shown in FIG. 2, the veneer panels T that belong to the same layer are laid such that their scarfing zones Z overlap.

Each veneer panel has two scarfing zones Z, namely one at the leading edge in the transport direction of the conveyor F and another one at the trailing edge. Typically, due to the manufacturing process, those scarfing zones are formed on the same side of the veneer panel, other than has been shown in FIG. 2. When laying the veneer panels, and at the latest when pressing the same, the veneer is bent in the scarfing zones Z such that the scarfing zones complement one another at least approximately to the nominal thickness d of the veneer panels. Any possible position tolerances may lead to a too large or too small overlap of the scarfing zones. However, due to the wavy in shape of the peripheries R of the scarfing zones, the defects that are caused by positioning errors are mitigated. In the scarfing zones, also the thickness of the veneer has wave-like variations. This waviness of the veneers in the scarfing zone is smoothen out during the pressing operation. In total, the wavy shape of the inner peripheries R of the scarfing zones has the effect that the transitions between the joining veneer panels T are advantageously blurred.

An apparatus and a method for manufacturing the scarfing zones Z with the wavy periphery R will now be described by reference to FIGS. 3 to 7.

FIG. 3 schematically shows one end of veneer peeling apparatus having a frame 10 of which a side wall 12, a rear wall 14 and a base 16 are visible here. Spindle sleeves 18 which serve for clamping a round timber 20, e. g. a tree trunk cut to length and decorticated, are rotatably supported in the side wall 12 and, correspondingly, in an opposite side wall which is not visible here.

Extending in parallel to the round timber 20, there is provided a knife bar 22 having a peeling knife 24 that is disposed on the back side of the knife bar 22 and is not visible in FIG. 1 and of which only the cutting edge has been shown in dashed lines. The opposite ends of the knife bar are held in the frame 10 by means of guides 26 so as to be adjustable in vertical direction.

A pressure roll unit 28 is arranged above the round timber 20, and two sets of pressure rollers 30 are rotatably supported at the pressure roll unit. The pressure rollers 30 are arranged on a bottom side of a carrier 32 which is suspended on a drive mechanism (not shown) and is movable relative to the frame 10 in vertical direction. By means of the drive mechanism, the pressure roll unit 28 is pressed against the round timber 20 such that the pressure rollers 30 roll on the periphery of the round timber and absorb a part of the reaction force that the peeling knife 24 exerts upon the round timber.

By means of the drive system which has not been shown and which acts upon the sleeves 18 and/or the pressure rollers 30, the round timber 20 is rotated about its longitudinal axis while the peeling knife 24 has its cutting edge set against the peripheral surface of the round timber such that an endless veneer web 36 is peeled-off from the round timber. The veneer web 36 is withdrawn in a position above the base 16, in a direction towards the viewer in FIG. 1, which is why the veneer web has been shown in section.

Whereas the pressure rollers 30 are arranged at a certain spacing from the side walls of the frame and from the ends of the round timber 20, the carrier 32 is extended beyond the pressure rollers towards the side wall 12 and carries, in the extended part, a milling head unit 38 having a milling head 40 that can be driven for rotation. The milling head 40 has a conical scarfing tool 42 which increases in diameter in the direction towards the side wall 12. More precisely, the scarfing tool is formed by knives which have not been shown in detail and the cutting edges of which are contained in a common enveloping surface with a conical shape. A radially projecting groove-forming tool 44 joins the outer end of the scarfing tool 42, which end has the largest diameter.

The milling head 40 and an associated drive system 46 are mounted on a free end of a rocker 48 the opposite end of which, facing away from the viewer in FIG. 1, is pivotably supported in bearing blocks 50 that project from the bottom side of the carrier 32. The rocker 48 has a forked configuration and carries on the side opposite to the milling head 40 a rotatable follower roll 52 the axis of which is aligned with the axis of rotation of the milling head 40. The outer diameter of the follower roll 52 is approximately equal to the smallest diameter of the conical scarfing tool 42.

Above the rocker 48, the carrier 32 forms an arm that projects in parallel with the rocker, and, between the free end of this arm and the free end of the rocker 48, there is arranged a compression spring 54 which biases the milling head unit 38 downwards and holds the follower roll 52 and the milling head 40 in engagement with the peripheral surface of the round timber 20.

The groove-forming tool 44 forms a groove 56 at a small distance from the end of the round timber 20, and adjoining the inner edge of this groove, there is a conical scarfing zone 58 which is formed by means of the scarfing tool 42 and merges into the peripheral surface of the round timber.

When a peripheral portion of the round timber 20 which has been processed with the milling head 40 in this way reaches the peeling knife 24, an outer peripheral layer is peeled-off, which layer forms the veneer web 36. The thickness of the veneer is smaller than the depth of the groove 56, so that, during peeling, a seam that is located beyond the groove 56 is separated from the main part of the veneer web. In this way, a neat butting edge 60, which is formed by one of the two sides of the previously formed groove 56, is formed at the main part of the veneer web 36. From this butting edge, the thickness of the veneer increases linearly in the scarfing zone 58 until the full thickness of the veneer is finally reached.

In FIG. 4, the sectional plane passes through the rocker 48, and the arm of the rocker that carries the follower roll 52 is visible. Moreover, the arrangement of the spring 54 relative to the pivotal bearing 62 can be seen. The spring 54 is a helical compression spring which, when compressed, exerts a torque onto the rocker 48 so that the follower roll 52 and the milling head are pressed against the round timber 20.

In the amount in which the radius of the round timber 20 decreases as the peeling of the veneer web 36 proceeds, the peeling knife 24 must be moved upwards, whereas the pressure roll unit 28 moves downwards by the same amount, so that the pressure rollers 30 stay engagement with the peripheral surface of the round timber 20. In this way, the correct position of the milling head unit 38 relative to the round timber 20 is maintained.

In a preferred embodiment, two milling head units 38 are arranged symmetrically at opposite ends of the carrier 32, and both are jointly adjusted by means of the pressure roll unit 28 in accordance with the decreasing radius of the round timber.

Further details of the apparatus described above are explained in the earlier utility model application DE 20 2015 102 518.

In a later processing step which has not been shown here, the veneer web 36 is divided into the individual veneer panels T, such that the scarfing zone 58 shown in FIG. 3 will form one of the scarfing zones Z. In the apparatus described here, the wavy shape of the inner periphery R of the scarfing zone Z is obtained due to the fact that, as has been shown in FIG. 4, the follower roll 52 has a slightly elliptical shape and thus deviates from the perfect circular shape (shown in dot-dashed lines in FIG. 4). Consequently, when the follower roll rolls over the round timber 20, the height of the rocker 48 and milling head 40 supported thereon oscillate periodically. As a consequence, the scarfing zone 58 acquires a wavy profile. The wave-like profile of the butting edge 60 (at the outer edge S of the scarfing zone in FIG. 1) is visible in FIG. 5. However, since, in FIG. 5, the veneer web 36 and the scarfing zone 58 thereof are seen from a side, the wavy shape of the inner periphery R of the scarfing zone cannot be seen here.

FIG. 6 shows the milling head 40 in its highest position relative to the veneer web 36, corresponding approximately to the position p1 in FIG. 5. In this position, the groove-forming tool 44 can just even severe the veneer. The conical peripheral surface of the milling head 40 is slightly lifted from the veneer web 36, so that only a relatively narrow scarfing zone is milled away and the inner periphery R of the scarfing zone has only a small distance from the butting edge 60.

FIG. 7 shows the milling head 40 in its lowest position, corresponding approximately to the position p2 in FIG. 5. Here, the butting edge 60 has a smaller height, and the milling head 40 mills away a substantially wider scarfing zone 58. In this way, the wavy shape of the periphery R is obtained, whereas the outer periphery S, corresponding to the butting edge 60, is formed by the groove-forming tool 44 independently of the height of the milling head and therefore extends straight. This has the advantage that, although the scarfing zone has a wave profile, the outer periphery S of the veneer panel T is straight, so that this edge of the veneer panel may for example be set against an alignment ruler, or the edge can be detected precisely by means of a camera or the like.

A slightly modified embodiment of the method has been shown in FIGS. 8 to 10. In FIG. 8, the surface of a veneer panel T, which surface forms a scarfing zone Z, is seen in a top plan view. In this case, however, both the inner periphery R and the outer periphery S of the scarfing zone are wavy. Only the vertices of the outer periphery S are clipped, so as to form an engagement edge S′ which is straight at least in certain sections. In order to form this scarfing zone, as shown in FIGS. 9 and 10, a milling head 40 is used which has a conical part with a larger length. FIG. 9 shows the milling head 40 in its lowest position in which relatively much material is milled away, so that the peripheries S and R are shifted into the right side in FIG. 9, i.e. towards the interior of the veneer web. FIG. 10 shows the milling head 40 in a lifted position in which the peripheries S and R of the scarfing zone are located further outwards and the groove-forming tool mills the engagement edge S′.

A method and an apparatus according to another embodiment will now described by reference to FIGS. 11 to 14.

FIG. 11 shows a scarfing apparatus 110 arranged at an end of a belt conveyor 112. Rectangular veneer panels T are supplied on the belt conveyor 112, which veneer panels have been dried earlier in a drying station which is not shown here.

The scarfing apparatus 110 has a rail-like frame 116 which extends transverse to the transport direction over the entire width of the belt conveyor at the end of this belt conveyor 112. A carriage 118 is guided on guide rails 120 and adapted to move along the frame 116.

An upper profile portion of the frame 116 forms a support 122 that is flush with the top side of the belt conveyor 112.

In the example shown, a camera 124 for detecting the time of the passage of the leading (outer) edge S of the veneer panel T is disposed above the belt conveyor 112. Then, the drive system for the belt conveyor 112 is controlled such that the veneer panel T is pushed beyond the end of the belt conveyor onto the support 122 until its periphery S slightly projects beyond the support 122.

A trimming device 128 and a grinding tool 130 are arranged on the carriage 118.

In the example shown, the trimming device 128 is a slitting saw having a circular saw blade 132 that is driven via a belt drive 134 and a rotating drive disk 132. Optionally, the trimming device may also be a chopper which completely chops the strip of material that is cut away.

The grinding tool 130 has an endless grinding belt 138 running over a pulley 140 and a corresponding cylindrical section 142 of the drive disk 132.

In a start position, the carriage 118 is located in an end portion of the frame 116, on the left end in FIG. 11, outside of the width of the belt conveyor 112, so that the trimming device and the grinding tool do not obstruct the advance of the veneer panel T. When the veneer panel has been pushed forward into the desired position, a pressure shoe 144 that extends in parallel with the support 142 is lowered by the means of a pneumatical, hydraulic or electric drive 146 so that it presses the edge zone of the veneer panel T against the support 122, thereby to immobilize the veneer panel. Subsequently, the carriage 118 travels from left to right in FIG. 11, so that the saw blade 132 cuts away the narrow edge strip from the projecting part of the veneer panel T, and then the grinding tool 120 grinds the bottom side of the veneer panel in a slanting configuration, thereby to scarf the veneer panel.

Subsequently, the pressure shoe 144 is lifted again, the veneer panel T is slightly withdrawn by means of the belt conveyor 112 and is then lifted by means of a suction device (not shown) and transferred onto a laying line on which a multi-layer string of veneer panels is laid as has been shown in FIG. 2.

It can be seen in FIG. 12 that the axis of the pulley 140 for the grinding belt 138 as well as the axis for the saw blade 132, which, however, is almost completely obscured in FIG. 12, are slightly inclined relative to the plane of the veneer panel T, so that the grinding tool creates, at the edge of the veneer panel, a scarfing zone Z with a wedge-shaped profile.

FIG. 12 further shows an edge strip 150 of the veneer panel, which, although it has already been separated from the veneer panel at the position of the grinding tool 30 by means of the saw blade 132, is still connected to the veneer panel, as long as it has not been broken away.

The trimming device 128 having the circular saw blade 132 can be seen in FIG. 13.

Further details of the device described above have been explained in the earlier patent application DE 10 2015 117 931.

In the cross-sectional view in FIG. 14, it can be seen that the support 122 has a wave profile at its top surface. Likewise, the pressure shoe 144 has a wave profile at its bottom side. The edge zone of the veneer panel T is clamped between the pressure shoe and the support and is thereby also deformed in wave fashion. Then, when the grinding belt 138 travels along the edge of the veneer panel, more or less material is removed alternatingly, so that a scarfing zone Z with a waving inner periphery is obtained. In contrast, the outer edge of the veneer panel is trimmed with the saw blade 132, so that, again, a straight outer periphery S is obtained, as is also shown in FIG. 1. The wave-like deformation of the veneer panel is largely cancelled again when the edge of the veneer panel is released from the pressure between the support 122 and the pressure shoe 144. However, the wave profile of the scarfing zone S remains because different amounts of material have been removed.

Optionally, the trimming device 128 can be set such that one obtains a scarfing zone with the configuration shown in FIG. 8.

What is claimed is:

1. A laminated veneer lumber product made from veneer panels which are glued and pressed to one another in a plurality of layers, at least one layer having a plurality of veneer panels which butt against one another and, at butt joints thereof, have a respective scarfing zone in which the thickness of each veneer panel decreases in the direction of an outer periphery of the scarfing zone, said outer periphery at the same time forming an edge of the veneer panel, and which is delimited in the inward direction by an inner periphery from which the veneer panel has a full thickness, wherein at least the inner periphery of the scarfing zone, as seen in plan view, runs in an undulating manner.

2. The product according to claim 1, wherein the outer periphery of the veneer panels is straight.

3. The product according to claim 1, wherein a surface of each veneer panel in the scarfing zone has a constant slope.

4. A method of forming a laminated veneer lumber product according to claim 1, including the steps of:
forming the scarfing zone with a tool which is moved relative to each veneer panel along a periphery of each veneer panel,
determining a height of the tool relative to the veneer panel being determined by a follower roll that rolls on the veneer panel, and
providing the follower roll with a non-circular outer periphery.

5. The method according to claim 4, further comprising the step of trimming the scarfing zone at said outer periphery with a groove-forming tool.

6. An apparatus for carrying out the method according to claim 4, comprising:
a milling unit on which the tool in the form of a milling head as well as the follower roll are arranged such that the follower roll rolls on the veneer panel and holds the tool in a working position thereof, the follower roll having a non-circular outer periphery.

7. The apparatus according to claim 6, wherein the tool comprises a groove-forming tool for trimming each veneer panel.

8. A method for forming a laminated veneer lumber product according to claim 1, comprising the steps of:
moving a tool relative to each said veneer panel along a periphery of this veneer panel in order to form the scarfing zone,
holding, at the time when the scarfing zone is formed, an edge portion of the veneer panel, which edge portion is adjacent to the path of travel of the tool, in a wave-shaped deformed condition between a support and a pressure shoe.

9. The method according to claim 8, further comprising the step of trimming an outer periphery of the scarfing zone with a cutting tool while the veneer panel is clamped between the support and the pressure shoe.

10. An apparatus for carrying out the method according to claim 8, comprising:
a frame which forms a support for each veneer panel,
an adjustable pressure shoe for pressing the veneer panel against the support, and
a carriage adapted to travel on the frame along a periphery of the veneer panel and carrying a tool for scarfing the veneer panel,
wherein the support and the pressure shoe each have a wave-shaped profile on the side facing the veneer panel.

11. The apparatus according to claim 10, further comprising a trimming device for separating an edge strip from the periphery of the veneer panel arranged on the carriage.
